(19) United States
(12) Patent Application Publication
(10) Pub. No.: US 2005/0075998 A1
(43) Pub. Date: Apr. 7, 2005

(54) Process of ipmp scheme description for digital item

(76) Inventors: Zhongyang Huang, Singapore (SG); Sheng Mei Shen, Singapore (SG); Ming Ji, Singapore (SG); Takanori Senoh, Osaka (JP)

Correspondence Address: GREENBLUM & BERNSTEIN, P.L.C., 1950 ROLAND CLARKE PLACE, RESTON, VA, 20191, US

(21) Appl. No.: 10/469,998

(22) PCT Filed: Feb. 6, 2003
(86) PCT No.: PCT/JP03/01217

Related U.S. Application Data
(60) Provisional application No. 60/354,527, filed on Feb. 8, 2002.

(51) Int. Cl. G06F 7/00

(52) U.S. Cl. 707/1

(57) ABSTRACT

This invention describes a way to represent IPMP scheme description for Digital Item to be used for MPEG-21 IPMP system. It aims to link IPMP with DID model of MPEG-21 framework. It also provides an interoperable and secure way for MPEG-21 IPMP system implementers to build the whole IPMP for Digital Item distribution and protection under MPEG-21 architecture. This invention also designs appropriate places to put the IPMP information including the important IPMP Tool related control information as well as other tool information. The information shall be put in DID Descriptor Statement at the beginning of Container, or tightly bound to the Resource element.

### TECHNICAL FIELD

The present invention relates to content distribution and protection in MPEG-21 scope, especially to such applications where the protected content is delivered and transferred based on MPEG-21 compliant devices.

### BACKGROUND ART

Today, many elements exist to build an infrastructure for the delivery and consumption of multimedia content. There is, however, no ‘big picture’ to describe how these elements, either in existence or under development, relate to each other. The aim for MPEG-21 is to describe how these various elements fit together. Where gaps exist, MPEG-21 will recommend which new standards are required. MPEG will then develop new standards as appropriate while other relevant standards may be developed by other bodies. These specifications will be integrated into the multimedia framework through collaboration between MPEG and these bodies.

MPEG-21 aims at setting out a vision for enabling transparent and augmented use of multimedia resources across a wide range of networks and devices used by different communities. The setting up ‘big picture’ is to describe how the specification of all the elements, which exist to build an infrastructure for the delivery and consumption of multimedia content. Now six key technical elements have been defined in MPEG-21: DID (Digital Item Declaration), DII&D or DIID (Digital Item Identification and Description), IPMP (Intellectual Property Management and Protection), RDD (Rights Data Dictionary), REL (Rights Expression Language), and DIA (Digital Item Adaptation).

Digital Items are defined as structured digital objects, including a standard representation and identification, and meta-data. This entity is the fundamental unit of distribution and transaction within the MPEG-21 framework as a whole. The means by which a Digital Item is defined is a Digital Item Declaration. The DID specifies the makeup, structure, and organization of a. Digital Item. The DID has defined a useful model formed by a set of abstract terms and concepts for defining Digital Items. Within this model, a Digital Item is the digital representation of “a work”, and as such, it is the item that is acted upon (managed, described, exchanged, collected, etc.) within the model. The goal of this model is to be as flexible and general as possible, while providing for the “hooks” that enable higher-level functionality. This, in turn, will allow the model to serve as a key foundation in the building of higher-level models in other MPEG-21 elements.

In MPEG standardisation group, people are working towards to standardise an IPMP (Intellectual Property Management and Protection) system that involves compliant terminal. All the terminals can represent a protected content that is encrypted and protected by following the same IPMP standard, no matter what kinds of IPMP tools they use. To achieve such a wide interoperability, IPMP provides download ability of tools, where tools can be retrieved remotely. IPMP also allows the terminal to choose its own favourite tool according to parametric description. An IPMP terminal can also aggregate several tools together to form a tool set (act as just one tool) according to some parametric aggregation.

The IPMP element should fit into DID model. But the current MPEG-21 IPMP terminal cannot meet the requirement for MPEG-21 framework based content—Digital Item distribution and protection. In other words, the IPMP scheme (information) such as IPMP tool information does not be included in the DID model, which is the core entity for compliant MPEG-21 terminal consuming and protecting the content.

In order to fit the flexible and interoperable IPMP system into whole MPEG-21 architecture, we should:
Design an appropriate and reasonable place to hold the IPMP information with other MPEG-21 elements information and referred resource under MPEG-21 DID model;
Provide the standard way to represent all IPMP related information for MPEG-21 IPMP system;
Provide the standard way for MPEG21-based application implementers to build a complaint MPEG-21 IPMP system based on IPMP information for MPEG-21 related “content” distribution and protection.

### DISCLOSURE OF INVENTION

On the content provider side, an incoming “content” is encoded and formed to be a MPEG-21 Digital Item including Digital Item Declaration (DID) with its referred resources. If the digital item is protected using MPEG-21 IPMP, IPMP Control Information and other IPMP information needs to be retrieved and constructed in DID.

After DID is received and sent to DID parser, the DID parser extracts IPMP scheme description (information) and sends to IPMP parser. Then the IPMP parser extracts all IPMP information and transfers the information to IPMP Tool Manager and Message Router in MPEG-21 IPMP system. Other IPMP Information such as IPMP message, Keys, etc could be put as OpaqueData in IPMP_Descriptor or the resource element in DID. When there is Rights Expression information under IPMP_Control_Info_Descriptor, it is transferred to REL parser. The parsed rights information can be enforced by Rights Management Tool carried in the DID or the resource through Descriptor Reference (remotely).

In other words, a method of processing IPMP Scheme description for Digital Item in a server of the content provider, includes the following steps of:
based on a flexible IPMP Scheme Description Schema and Language to describe IPMP control information and tool information commonly used for IPMP system to protect content, creating an IPMP scheme descriptor with IPMP information inside based on the IPMP Scheme Description Schema and Language when a Digital Item Declaration (DID) with its referred resource is created and encoded;
incorporating the IPMP scheme descriptor to the DID in a specified place to be distributed to Users; and
transferring the DID to a terminal,
wherein the terminal includes an IPMP Parser which operates based on the IPMP Scheme Description Schema and Language to extract the IPMP scheme descriptor from the DID, and
wherein the terminal includes one of a Tool Manager and Message Router to interpret the IPMP information inside the IPMP scheme descriptor extracted and transferred by the IPMP Parser and enforce protection on the content in the terminal.

Note that one primary feature of the above method is a step of incorporating the IPMP scheme descriptor to the DID in a specified place in a server. Therefore, the present invention can achieve advantages discussed later at least with the “incorporating” step. Component of the terminal can be omitted in this invention related to the server.

Further, the present invention provides a method of processing IPMP Scheme description for Digital Item in a terminal of a consumer of the content. Before performing the method, based on a flexible IPMP Scheme Description Schema and Language to describe IPMP control information and tool information commonly used for IPMP system to protect content, a server creates an IPMP scheme descriptor with IPMP information inside based on the IPMP Scheme Description Schema and Language when a Digital Item Declaration (DID) with its referred resource is created and encoded. The server incorporates the IPMP scheme descriptor to the DID in a specified place to be distributed to Users. The server transfers the DID to a terminal which is installed with an IPMP Parser based on the IPMP Scheme Description Schema and Language to extract the IPMP scheme descriptor from the DID.

Then, the method including steps of:
receiving the DID and its referred resource with the IPMP information in the IPMP scheme descriptor in the terminal;
extracting the IPMP scheme descriptor with the IPMP information from the received DID;
parsing the IPMP scheme descriptor by the IPMP Parser in the terminal;
transferring the IPMP information to one of IPMP Tool Manager and Message Router in the terminal;
Interpreting the IPMP information inside the IPMP scheme descriptor which enforces protection on the content in the terminal: and
activating the protection on resources in the terminal.

Note that one primary feature of the above method is in that the terminal can deal the IPMP scheme descriptor placed within a specified place of the DID. Therefore, an invention which includes at least one step to deal IPMP scheme descriptor or DID can achieve the advantages discussed later.

The above methods are explained as the server and the terminal with components which performs the above steps, respectively.

The present invention solves a problem of designing the standard way to be used in MPEG-21 Digital Item consuming in a secure manner, by providing a standard way to represent all IPMP related information for MPEG-21 IPMP system implementers to build the whole IPMP system for MPEG-21 related “content” distribution and protection;
This invention also solves the problem of incorporating IPMP element/part into whole MPEG-21 framework, by designing appropriate and reasonable place to hold the IPMP information under MPEG-21 DID model.

The details will be elaborated in the Embodiments.

### BRIEF DESCRIPTION OF DRAWINGS

This and other objects and features of the present invention will become clear from the subsequent description of a preferred embodiment thereof made with reference to the accompanying drawings, in which like parts are designated by like reference numerals and in which:

FIG. 1 is a diagram showing an example of MPEG-21 content model architecture;

FIG. 2 is a diagram showing an example of of MPEG-21 system architecture;

FIG. 3 is a diagram showing a relationship between DID, DIID and IPMP_Scheme;

FIG. 4 is a flowchart showing how IPMP information is transmitted between DID and IPMP system;

FIG. 5 is a diagram showing an architecture of IPMP_Scheme XML schema; and

FIG. 6 is a diagram showing a data flow in a server and a terminal.

### BEST MODE FOR CARRYING OUT THE INVENTION

Digital Items are defined as structured digital objects, including a standard representation and identification, and meta-data, which subordinates to the respective Digital Items to explain respective contents, for example, data on a title and copy authorization for motion picture. This entity is the fundamental unit of distribution and transaction within the MPEG-21 framework as a whole. Note that this invention can be applied to any formats other than MPEG-21, for example, to MPEG-7. Focusing on this unit related to MPEG-21, the six technical elements existing under MPEG-21 are briefly described and listed below:
Digital Item Declaration (a uniform and flexible abstraction and interoperable schema for declaring Digital Items): it specifies the mechanism for declaring the structure and makeup of Digital Items;
Digital Item Identification and Description (a framework for identification and description of any entity regardless of its nature, type or granularity): it specifies how Digital Items and parts and collections thereof can be described and uniquely identified;
Intellectual Property Management and Protection Architecture or Tool Representation and Communication System (the means to enable content to be persistently and reliably managed and protected across a wide range of networks and devices): it specifies information related to intellectual property management and protection associated with the Digital Item;
Rights Expression Language (a machine-readable language that can declare rights and permissions using the terms as defined in the Rights Data Dictionary): it specified flexible, interoperable mechanisms to support transparent and augmented use of digital resources and express their rights and interests in a way that addresses issues of privacy and use of personal data;
Rights Data Dictionary (a set of clear, consistent, structured and integrated definitions of terms for use in the MPEG-21 Rights Expression Language);
Digital Item Adaptation: provide tools to support resource adaptation, descriptor (‘metadata’) adaptation, and Quality of Service management.

A “tool” referred to in this specification is a computer executable program to execute one or more predetermined processes such as mutual authentication, decryption which comforms to Data Encryption Standard (DES). Such programs are available in the form of Dynamic Link Libraries (DLLs), JAVA code program modules, etc.

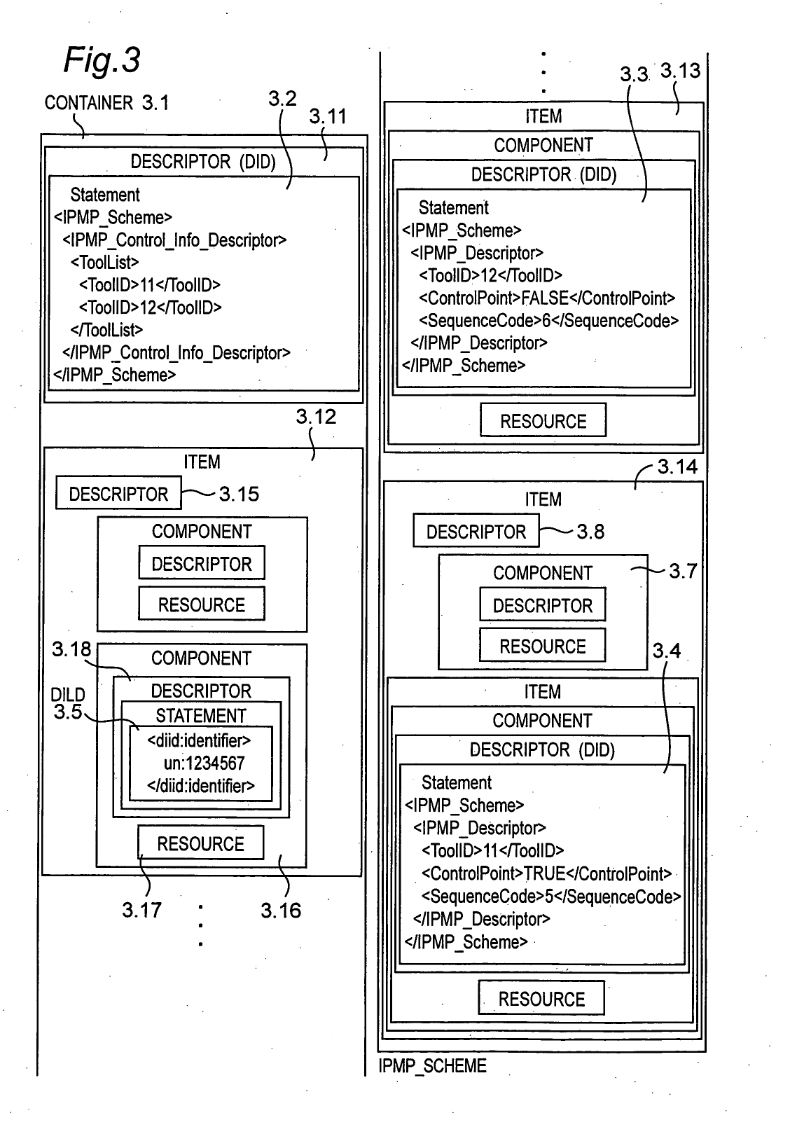

The means by which a Digital Item is defined is a Digital Item Declaration (DID) (the whole structure of FIG. 3). The DID specifies the makeup, structure, and organization of a Digital Item. This includes a list of the resources, relevant metadata, and the relationships among the parts. The DID has defined a useful model (unit 3.1 in FIG. 3) formed by a set of abstract terms and concepts such as Container, Item, Component, Anchor, Descriptor, Condition, Choice, Selection, Annotation, Assertion, Resource, Fragment, Statement, etc (e.g. shown in FIG. 3 unit 3.7, 3.8, 3.13) for defining Digital Items. Within this model, a Digital Item is the digital representation of “a work”, and as such, it is the item that is acted upon (managed, described, exchanged, collected, etc.) within the model. The goal of this model is to be as flexible and general as possible, while providing for the “hooks” that enable higher-level functionality. This, in turn, will allow the model to serve as a key foundation in the building of higher-level models in other MPEG-21 elements. The IPMP (Intellectual Property Management and Protection) element should also fit into this model.

Initially, by referring to FIG. 3, organization of container 3.1 of a Digital Item is described. Container 3.1 with the following arrangement is created by a server by placing elements. From the beginning of Container 3.1, Container 3.1 has Descriptor 3.11, Item 3.12, 3.13, and 3.14 in this order and is described in text format by using XML.

Descriptor 3.11 shows, for example, what types of Items are included in the container 3.1 and also called as Digital Item Declaration (DID), or as Container Descriptor. Descriptor 3.11 includes IPMP scheme descriptor 3.2, shown as “Statement”. At the beginning of IPMP scheme descriptor 3.2, IPMP control information descriptor (IPMP_Control_Info_Descriptor) is placed, which describes a list of tool(s) to be used when an encode of a server encodes a content.

Items 3.12 to 3.14 respectively relate to content such as motion pictures, still pictures, and audio. For example, Item 3.12 includes Descriptor 3.15 and one or more Components such as Component 3.16. Descriptor 3.15 describes unique information on Item 3.12. Component 3.16 includes resource 3.17 and Descriptor 3.18 for resource 3.17. The Descriptor (DID) 3.18 includes Digital Item Identification and Description (DIID) 3.5 which identifies Resource 3.17 by a identifier. Resource 3.17 is an actual data such as motion pictures, still pictures, and audio. Alternately, Resource 3.17 may be URL (Uniform Resource Locator) which specifies a server in a network, in which the actual data is stored.

Each arrangement of Items 3.13 and 3.14 is the same as that of item 3.12. Items 3.13 and 3.14 have a Component which includes Descriptor (DID) and Resource. The respective Descriptors (DID) have Statements 3.3 and 3.4 as IPMP Scheme Descriptors. The IPMP Scheme Descriptor has an IPMP descriptor which specifies necessary IPMP information on one of completely described IPMP Tool information and related control message for specific protected resource. IPMP descriptor is placed in the nearest resource Descriptor (i.e. a Descriptor (DID) corresponding to the resource) within the same Component parent element under the DID, to be distributed to Users. Detailed explanation of the above elements is described later.

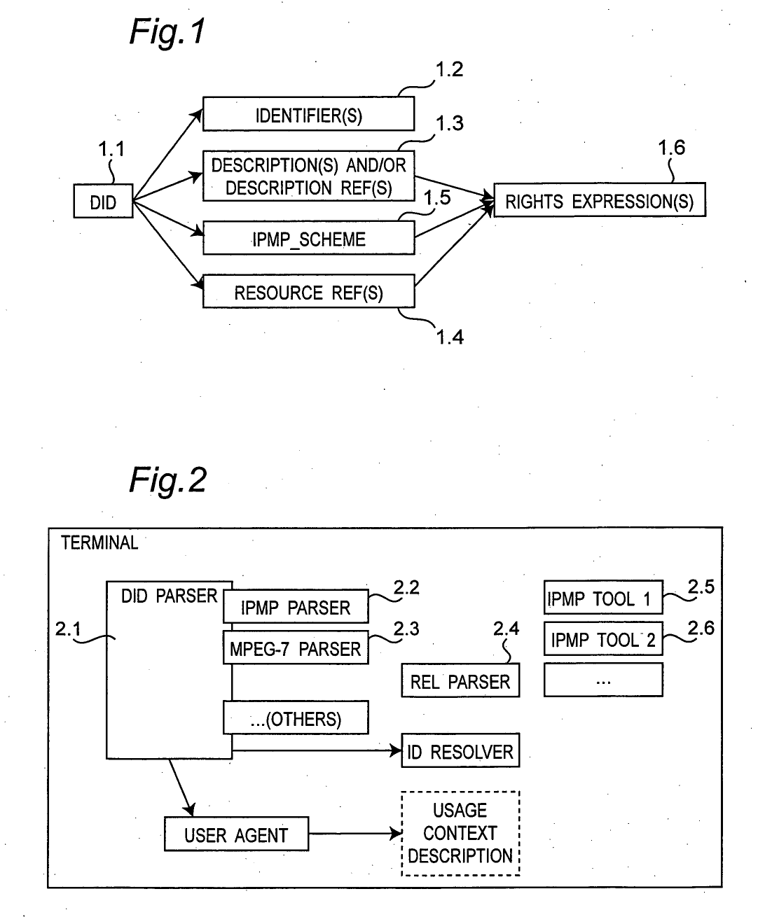

FIG. 1 shows an MPEG-21 content model architecture. The unit 1.1 DID specifies the makeup, structure, and organization of a Digital Item as shown in unit 3.1. The unit 1.1 DID includes a list of the Identifications (unit 1.2) such as ID number(s) of the Digital Item, Descriptions (unit 1.3) such as a title of the Digital Item and copyright information, referred Resources (unit 1.4) such as a. URL (Uniform Resource Locator) of a resource, and the relationships among the parts.

The IPMP framework is a terminal system interface that supports tools for enforcing rights expressions that might be associated with (by direct containment, or some other linkage). We add one unit 1.5 “IPMP_Scheme” under DID model to try to link DID with IPMP framework. The unit 1.6 Rights Expressions may be contained in descriptions (and/or refs), and/or resource ref(s) and/or IPMP_Scheme. The unit 1.6 Rights Expressions has information on copyright, by which information in units 1.3 through 1.5 can be referred. The unit 1.6 can be included in the end of statement 3.2 (FIG. 3), in statement 3.3 of Component within Item 1.13 (FIG. 3), or in any statement.

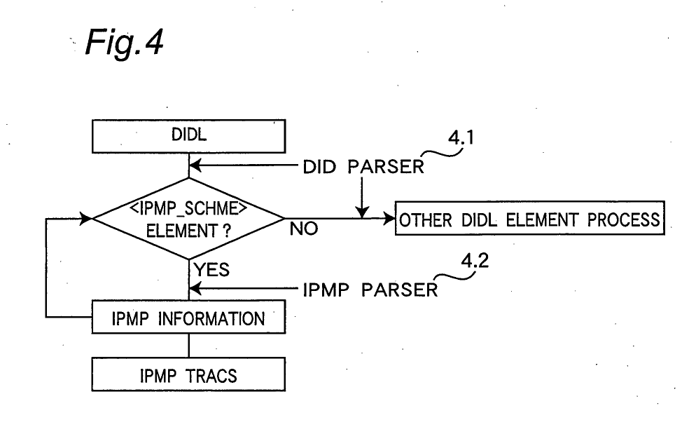

FIG. 2 shows an MPEG-21 system architecture. Under the MPEG-21 framework, when a clear DI Declaration coming, it is parsed by DID Parser (module 2.1). In this invention, it concerns, while parsing a part of the Declaration, the DID Parser encounters a Descriptor that identifies an IPMP_Scheme description that is used to protect the contents (DI) or part of the contents (Component Resource). The DID Parser will invoke the module 2.2 IPMP parser to interpret IPMP_Scheme schema and then passes the IPMP_Scheme information together with the protected content information (or the means to obtain it) to the IPMP system. The explanation about the IPMP scheme (information) transmission between DID parser (module 4.1) and IPMP parser (module 4.2) can also be seen in a flowchart of FIG. 4.

Note that the protected content can itself be another DID, or a fragment of a DID, or a resource. The two parts/descriptors of IPMP_Scheme under the entire Digital Item Declaration can be signed/encrypted separated from whole DID or as part of signed/encrypted Declaration.

For the same situation, the DID Parser encounters a Descriptor containing an MPEG-7 description, and invokes the module 2.3 MPEG-7 parser, passing the description to it. The MPEG-7 description itself may be protected, and the protection scheme can be identified by another IPMP_Descriptor within the same parent Descriptor.

The Digital Item Declaration arrives by some means. In some cases, the entire Declaration may be encrypted or signed. It is also possible that only the IPMP scheme descriptor under DID are encrypted or signed.

In FIG. 2, different modules existing in the MPEG-21 system architecture can be briefly described as following:

1) DID Parser (Module 2.1, 4.1)

It receives the DID from the MPEG-21 (De)Mux and parses the DIDL text declaring the structure of the Digital Item. When DID Parser parses the DIDL text and finds no<IPMP_Scheme> Element (“No” in FIG. 4), DID parser performs other DIDL element Process. On the other hand, when the DID Parser finds <IPMP_Scheme> Element (“Yes” in FIG. 4), the IPMP information text of DIDL is sent to IPMP Parser 4.2.

2) IPMP Parser (Module 2.2, 4.2)

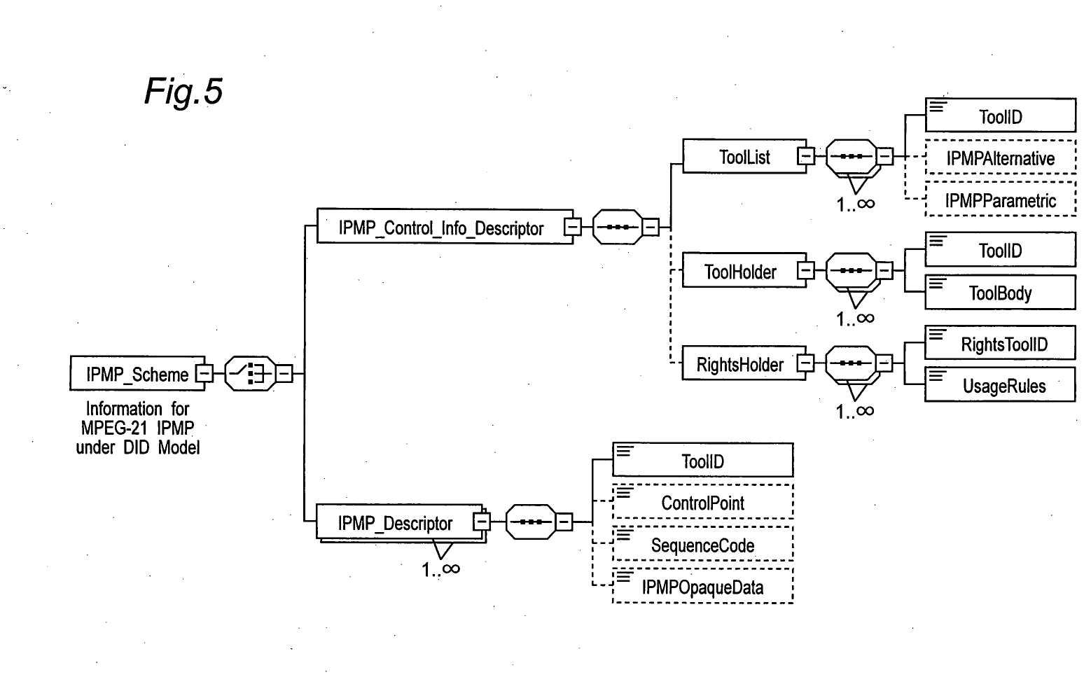

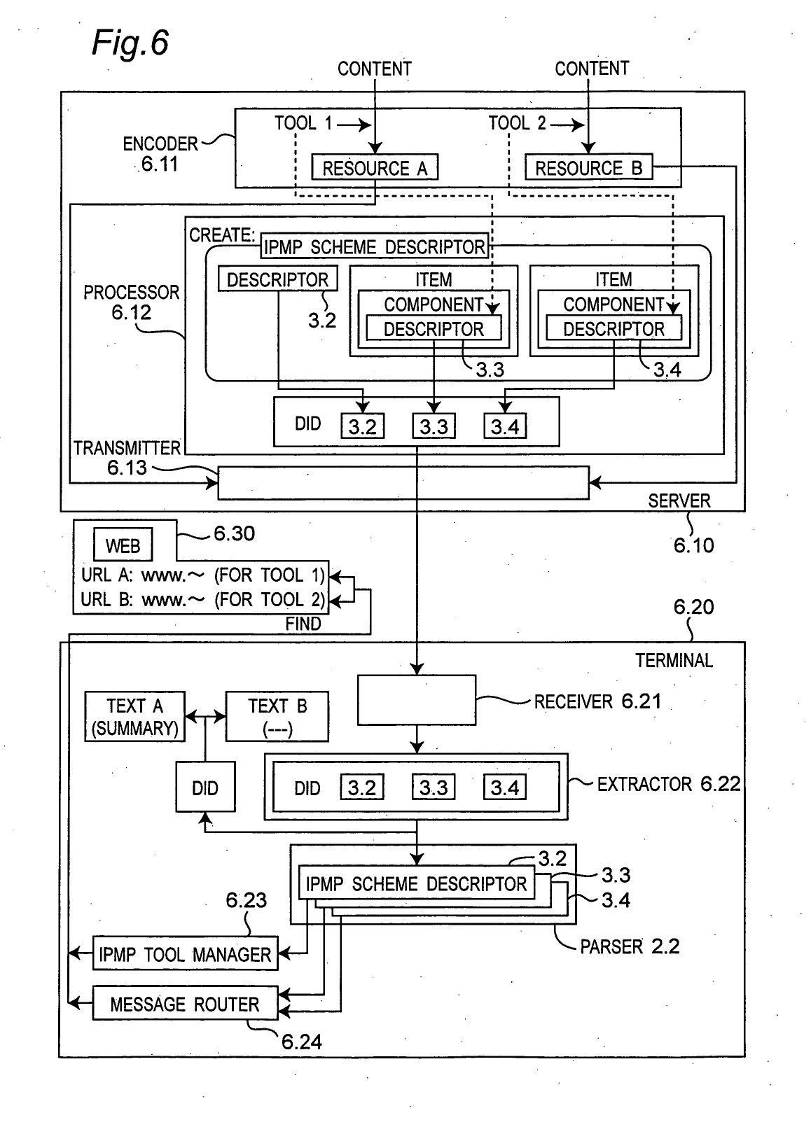

It receives the IPMP information text (in XML with hierarchical structure as shown in FIG. 5) held in DID and parses it. It will usually use IPMP Tool(s) to act upon this IPMP information (and other information, e.g. REL). After the IPMP Parser parses the IPMP information, Digital Item (i.e. content) is processed according to the parsed IPMP information by, for example, IPMP Tool Manager 623/Message router 6.24 (FIG. 6), which is shown as “IPMP TRACS” in FIG. 4.

3) REL Parser (Module 2.4)

It receives the REL text (in XML) held in DID or IPMP information and parses it.

The whole DID model includes Digital Item Identification and Description (DIID) (unit 3.5) and IPMP information (unit 3.2, 3.3, 3.4) held in IPMP_Scheme descriptor and the relationship between DID (MPEG-21 part 2), DIID (MPEG-21 part 3), and IPMP (MPEG-21 part 4) can be seen in FIG. 3. Two descriptors, “IPMP_Control_Info_Descriptor” (unit 3.2) and “IPMP_Descriptor” (unit 3.3, 3.4) in FIG. 3 can provide different IPMP information description for MPEG-21 IPMP system to protect the MPEG-21 content.

MPEG-21 IPMP_Scheme Descriptor—IPMP_Control_Info_Descriptor and IPMP_Descriptor

The MPEG-21 IPMP system has been designed to provide a framework and specifications to allow the same protected content to be consumed on different vendors' terminals; it also allows the same content to be protected by different vendors' IPMP Tools. It can provide interoperability, renewability and flexibility through IPMP Tools. (IPMP Tools: modules 2.5, 2.6 that perform (one or more) IPMP functions such as authentication, decryption, watermarking, etc.)

So in the two proposed descriptors of IPMP_Scheme, the most important information/messages needed to transferring between DID model and IPMP system are IPMP Tools related and other IPMP control information.

IPMP_Control_Info_Descriptor

A Container is a structure that allows Items to be grouped. These groupings of Items can be used to form logical packages (for transport or exchange) or logical shelves (for organization). Descriptor “labelling” of Container allows including information that is appropriate for the purpose of the grouping. IPMP_Control_Info_Descriptor is designed under the outmost Container Descriptor's Statement. It includes the IPMP Control Information, which contains necessary information like Tool List, IPMP Tool Holder and IPMP Rights Holder.

The IPMP Tool List identifies and enables selection of, the IPMP Tools required to process and protect the Content. It includes a list of IPMP tools and is used to specify all IPMP tools that should be used in order to consume the content. By this Tool List, the terminal will determine the IPMP Tools obtained either from local terminal, carried in the content or obtained from remote sites. ToolID is the identifier of the logical IPMP Tool required by the Device and represented by an UnsignedInteger. The Tool List may include IPMPAlternative and IPMPParametric to denote a list of alternate IPMP Tools and the parametric description of an IPMP Tool. These two elements definition and semantic can be further extended.

Tool Holder maybe cases whereby content (DI) itself carry the binary IPMP Tool. The device may retrieve the IPMP Tool from the content, load it, instantiate it and immediately use it in order to play out the content. It includes ToolID and ToolBody represented by Bytes.

Rights Holder conveys the Rights/Usage Rules associate with the IPMP protected content. Similarly, it includes Rights ToolID especially for Rights Parser such as REL parser (module 2.4), proprietary rights management tool (XrML parser, ODRL parser, etc). Bytes-represented Usage Rule transformed from XML-based Rights Expression is another element of Rights Holder. It has been discussed widely and intensively on the MPEG-21 scope that where the IP (REL related Rights/Usage Rules information) should be located and how to deliver it. One solution is that the rights information should be packaged into the form of a ticket or a voucher out of band. The ticket usually includes detailed rights for the content using a certain rights language. Descramble key may also be carried in the ticket. A sort of ID scheme should be also included in the ticket, so that the voucher and ticket can be uniquely and unambiguously linked with certain content. This kind of rights conveyance and delivery is an implementation issue, and MPEG does not need to standardize it. Another one is that rights information should reside in the individual resource. In this way content and rights information are tightly bounded together. In this invention, a new holder RightsHolder in IPMP_Control_Info_Descriptor under IPMP_Scheme is proposed to carry rights information.

IPMP_Descriptor

A resource is an individually identifiable asset such as a video or audio clip, an image, or a textual asset. A resource may also potentially be a physical object. All resources must be locatable via an unambiguous address. IPMP_Descriptor is designed to make the resource in the Item is covered by completely described IPMP Tool information and related control message for consuming such resource. It should reside in the nearest Descriptor element of the resource element within the same Component parent element.

This descriptor also conveys the control point information of the IPMP Tool, including at which control point the tool resides (before or after the practical resource consuming), and its sequence relation to other tools reside at the control point.

ToolID has the same concept as defined in IPMP_Control_Info_Descriptor and clearly give the Tool information that which Tool is used to protect the attached resource. ControlPoint value denoted by a Boolean type specify the IPMP control point at which the IPMP tool resides and actives before or after the practical resource consuming. In other words, in the case the Boolean type is “True”, tools are used before decoding the content. In the case “False”, tools are used after decoding the content. SequenceCode value specifying the relation of the IPMP Tool to IPMP Tool(s) residing at the same control point. The value of the element specifies the priority of this IPMP Tool at this specific control point. Final element in IPMP_Descriptor is IPMPOpaqueData which indicates opaque data to control the IPMP Tool. The opaque data contains information dependent on each user.

Other IPMP Information such as IPMP message, Keys, etc could be put in the resource element in DID.

Schema for Proposed IPMP_Scheme Descriptor

```
<?xml version=“1.0” encoding=“UTF-8”?>
<!-- edited with XML Spy v4.0 (http://www.xmlspy.com) by Huang Zhongyang (Panasonic
Singapore Laboratories Pte Ltd) -->
<xs:schema xmlns:xs=“http://www.w3.org/2001/XMLSchema” elementFormDefault=“qualified”
attributeFormDefault=“unqualified”>
  <xs:element name=“IPMP_Scheme”>
    <xs:annotation>
      <xs:documentation>Information  for  MPEG-21  IPMP  under  DID
Model</xs:documentation>
    </xs:annotation>
    <xs:complexType>
      <xs:choice>
        <xs:element name=“IPMP_Control_Info_Descriptor”>
          <xs:complexType>
            <xs:sequence>
              <xs:element name=“ToolList”>
                <xs:complexType>
                  <xs:sequence maxOccurs=“unbounded”>
                    <xs:element name=“ToolID” type=“xs:unsignedInt”/>
                    <xs:element name=“IPMPAlternative” minOccurs=“0”/>
                    <xs:element name=“IPMPParametric” minOccurs=“0”/>
                  </xs:sequence>
                </xs:complexType>
              </xs:element>
              <xs:element name=“ToolHolder” minOccurs=“0”>
                <xs:complexType>
                  <xs:sequence maxOccurs=“unbounded”>
                    <xs:element name=“ToolID” type=“xs:unsignedInt”/>
                    <xs:element name=“ToolBody” type=“xs:byte”/>
                  </xs:sequence>
                </xs:complexType>
              </xs:element>
              <xs:element name=“RightsHolder” minOccurs=“0”>
                <xs:complexType>
                  <xs:sequence maxOccurs=“unbounded”>
                    <xs:element name=“RightsToolID” type=“xs:unsignedInt”/>
                    <xs:element name=“UsageRules” type=“xs:byte”/>
                  </xs:sequence>
                </xs:complexType>
              </xs:element>
            </xs:sequence>
          </xs:complexType>
        </xs:element>
        <xs:element name=“IPMP_Descriptor” maxOccurs=“unbounded”>
          <xs:complexType>
            <xs:sequence>
              <xs:element name=“ToolID” type=“xs:unsignedInt”/>
              <xs:element name=“ControlPoint” type=“xs:boolean” minOccurs=“0”/>
              <xs:element name=“SequenceCode” type=“xs:unsignedInt” minOccurs=“0”/>
              <xs:element name=“IPMPOpaqueData” type=“xs:byte” minOccurs=“0”/>
            </xs:sequence>
          </xs:complexType>
        </xs:element>
      </xs:choice>
    </xs:complexType>
  </xs:element>
</xs:schema>
```

FIG. 5 shows the architecture of the IPMP_Scheme XML Schema where its semantic of elements in the schema can refer to a section explaining “MPEG-21 IPMP_Scheme descriptor—IPMP_Control_Info_Descriptor and IPMP_Descriptor”.

Now, general operations of a server of a content provider and a terminal of a consumer are described below. FIG. 6 is a diagram showing data flow in a server 6.10 and a terminal 6.20. An encoder 6.11 of server 6.10 encodes a content by using tool 1 to creat encoded resource A, and encodes the other content by using tool 2 create encoded resource B. A processor 6.12 of server 6.10 generates information on encoded resources within the IPMP Scheme Descriptor. The IPMP Scheme Descriptor contains three Descriptors 3.2 to 3.4 containing IPMP information, which are the same Descriptors as shown in FIG. 3. Note that Descriptor 3.3 of Component within the Item indicates information on Tool 1, for example, information on URL (Uniform Resource Locator) where the tool 1 is available. Similarly, Descriptor 3.4 indicates information on Tool 2. The processor 6.12 further creates DID with embedding three Descriptors 3.2 to 3.4 in it. Then, transmitter 6.13 of server 6.10 transmits the DID to terminal 6.20. With the DID, transmitter 6.13 also transmits encoded resources A and B to terminal 6.20.

Receiver 6.21 of Terminal 6.20 receives the DID. Then Extractor 6.22 of Terminal 6.20 extracts IPMP scheme descriptors 3.2 to 3.4 with IPMP information from the received DID. IPMP parser 2.2 (FIG. 2) parses the extracted IPMP scheme descriptors 3.2 to 3.4 to transfer the IPMP information to IPMP Tool. Manager 623/Message router 6.24 in terminal 6.20. In the case that IPMP information in the IPMP scheme descriptors is for tool(s), the information is sent to IPMP Tool Manager 6.23. In the case that information on controls for interpretation is included in the IPMP scheme descriptors, the information is sent to Message router 6.24 to be sent to appropriate target. In other words, IPMP Tool Manager 6.23/Message router 6.24 interpret the IPMP information to activate protection on resources in terminal. More specifically, IPMP Tool Manager 6.23/Message router 6.24 accesses one or more web sites within Web 6.30 indicated by URL A and URL B to find and obtain Tool 1 and Tool 2. Then, terminal 6.20 can decode the encoded resources A and B by using Tools 1 and 2. Remaining DID indicates Text A which is a summary for resource A, and indicates Text B. According to the above operations, the consumer can enjoy the content. Note that FIG. 2 shows components of terminal 6.20 in more detail.

According to a server of the present invention includes:
A means to define the place for DID to include the IPMP information;
A means to define an IPMP scheme description for Digital Item based on XML schema to be effectively constructed and organized;
A means to pass IPMP control information to MPEG-21 IPMP system before accessing any Digital Item Resources in MPEG-21 architecture; and
A means to protect Resources using adjacent IPMP information in MPEG-21 compliant terminal.

The present invention can provide processing methods of a server and a terminal, and further provides a server and a terminal as follows:

(1) Methods of IPMP Scheme Description for Digital Item in MPEG-21 Architecture, Including the Following Steps of:

Specifying and defining a flexible IPMP Scheme Description Schema and Language to describe IPMP control information and tool information commonly used for MPEG-21 IPMP system to protect MPEG-21 content;
Creating IPMP scheme descriptor with IPMP information inside based on the said IPMP Scheme Description Schema and Language when a MPEG-21 DID with its referred Resource is created and encoded;
Incorporating the said IPMP scheme descriptor to the said MPEG-21 DID in a specified place to be distributed to Users;
Implementing a MPEG-21 terminal with building a IPMP Parser based on the said IPMP Scheme Description Schema and Language to extract the said IPMP scheme descriptor from the said DID and transfer them to MPEG-21 IPMP tool Manager/Message Router;
Building the said terminal with the said Tool Manager/Message Router to interpret the said IPMP information inside the said IPMP scheme descriptor and enforce the protection on the MPEG-21 content in the said terminal.
   (2) Methods of IPMP Scheme Description for Digital Item in MPEG-21 Architecture, Including the Following Steps of:
Specifying and defining a flexible IPMP Scheme Description Schema and Language to describe IPMP control information and tool information commonly used for MPEG-21 IPMP system to protect MPEG-21 content;
Creating IPMP scheme descriptor with IPMP information inside based on the said IPMP Scheme Description Schema and Language when a MPEG-21 DID With its referred Resource is created and encoded;
Incorporating the said IPMP scheme descriptor to the said MPEG-21 DID in a specified place to meet the MPEG-21 IPMP system specifications, to be distributed to Users;
Implementing a MPEG-21 terminal with building a IPMP Parser based on the said IPMP Scheme Description Schema and Language to extract the said IPMP scheme descriptor from the said DID and transfer them to MPEG-21 IPMP tool Manager/Message Router;
Building the said terminal with the said Tool Manager/Message Router to interpret the said IPMP information inside the said IPMP scheme descriptor and enforce the protection on the MPEG-21 content in the said terminal;
Receiving the said DID and its referred Resource with the said IPMP information in the said IPMP scheme descriptor in the said terminal;
Extracting the said IPMP scheme descriptor with the said IPMP information from the received DID;
Parsing the said IPMP scheme descriptor by the said IPMP Parser in the said terminal and transferring the said IPMP information to IPMP Tool Manager/Message Router;
Interpreting the said IPMP information by IPMP Tool Manager/Message Router to activate the protection on Resources in the said terminal.
   (3) Methods of IPMP Scheme Description for Digital Item in MPEG-21 Architecture, Including the Following Steps of:
Specifying and defining a flexible IPMP Scheme Description Schema and Language to describe IPMP control information and tool information commonly used for MPEG-21 IPMP system to protect MPEG-21 content;
Creating IPMP scheme descriptor with IPMP information inside based on the said IPMP Scheme Description Schema and Language when a MPEG-21 DID with its referred Resource is created and encoded;
Producing IPMP control information descriptor, part of the said IPMP scheme descriptor, based on the said IPMP Scheme Description Schema and Language to specify necessary IPMP information like Tool List, IPMP Tool Holder and IPMP Rights Holder;
Incorporating the said IPMP scheme descriptor to the said MPEG-21 DID in a specified place to meet the MPEG-21 IPMP system specifications, to be distributed to Users;
Implementing a MPEG-21 terminal with building a IPMP Parser based on the said IPMP Scheme Description Schema and Language to extract the said IPMP scheme descriptor from the said DID and transfer them to MPEG-21 IPMP tool Manager/Message Router;
Building the said terminal with the said Tool Manager/Message Router to interpret the said IPMP information inside the said IPMP scheme descriptor and enforce the protection on the MPEG-21 content in the said terminal.
Receiving the said DID and its referred Resource with the said IPMP information in the said IPMP descriptor in the said terminal;
Extracting the said IPMP descriptor with the said IPMP information from the received DID;
Parsing the said IPMP scheme descriptor by the said IPMP Parser in the said terminal and transferring the said IPMP information to IPMP Tool Manager/Message Router;
Interpreting the said IPMP information by IPMP Tool Manager/Message Router to activate the protection on Resources in the said terminal.
   (4) Methods of IPMP Scheme Description for Digital Item in MPEG-21 Architecture, Including the Following Steps of:
Specifying and defining a flexible IPMP Scheme Description Schema and Language to describe IPMP control information and tool information commonly used for MPEG-21 IPMP system to protect MPEG-21 content;
Creating IPMP scheme descriptor with IPMP information inside based on the said IPMP Scheme Description Schema and Language when a MPEG-21 DID with its referred Resource is created and encoded;
Producing IPMP control information descriptor, part of the said IPMP scheme descriptor, based on the said IPMP Scheme Description Schema and Language to specify necessary IPMP information like Tool List, IPMP Tool Holder and IPMP Rights Holder;
Incorporating the said IPMP scheme descriptor to the said MPEG-21 DID in a specified place to meet the MPEG-21 IPMP system specifications, to be distributed to Users;
Placing the said IPMP control information descriptor under the said MPEG-21 DID at the beginning of Container Descriptor's Statement element, to be distributed to Users;
Implementing a MPEG-21 terminal with building a IPMP Parser based on the said IPMP Scheme Description Schema and Language to extract the said IPMP scheme descriptor from the said DID and transfer them to MPEG-21 IPMP tool Manager/Message Router;
Building the said terminal with the said Tool Manager/Message Router to interpret the said IPMP information inside the said IPMP scheme descriptor and enforce the protection on the MPEG-21 content in the said terminal.
Receiving the said DID and its referred Resource with the said IPMP information in the said IPMP descriptor in the said terminal;
Extracting the said IPMP descriptor with the said IPMP information from the received DID;
Parsing the said IPMP scheme descriptor by the said IPMP Parser in the said terminal and transferring the said IPMP information to IPMP Tool Manager/Message Router;
Interpreting the said IPMP information by IPMP Tool Manager/Message Router to activate the protection on Resources in the said terminal.
   (5) Methods of IPMP Scheme Description for Digital Item in MPEG-21 Architecture, Including the Following Steps of:
Specifying and defining a flexible IPMP Scheme Description Schema and Language to describe IPMP control information and tool information commonly used for MPEG-21 IPMP system to protect MPEG-21 content;
Creating IPMP scheme descriptor with IPMP information inside based on the said IPMP Scheme Description Schema and Language when a MPEG-21 DID with its referred Resource is created and encoded;
Producing IPMP descriptor, part of the said IPMP scheme descriptor, based on the said IPMP Scheme Description Schema and Language to specify necessary IPMP information like completely described IPMP Tool information and related control message for specific protected Resource;
Incorporating the said IPMP scheme descriptor to the said MPEG-21 DID in a specified place to meet the MPEG-21 IPMP system specifications, to be distributed to Users;
Implementing a MPEG-21 terminal with building a IPMP Parser based on the said IPMP Scheme Description Schema and Language to extract the said IPMP scheme descriptor from the said DID and transfer them to MPEG-21 IPMP tool Manager/Message Router;
Building the said terminal with the said Tool Manager/Message Router to interpret the said IPMP information inside the said IPMP scheme descriptor and enforce the protection on the MPEG-21 content in the said terminal.
Receiving the said DID and its referred Resource with the said IPMP information in the said IPMP descriptor in the said terminal;
Extracting the said IPMP descriptor with the said IPMP information from the received DID;
Parsing the said IPMP scheme descriptor by the said IPMP Parser in the said terminal and transferring the said IPMP information to IPMP Tool Manager/Message Router;
Interpreting the said IPMP information by IPMP Tool Manager/Message Router to activate the protection on Resources in the said terminal.
   (6) Methods of IPMP Scheme Description for Digital Item in MPEG-21 Architecture, Including the Following Steps of:
Specifying and defining a flexible IPMP Scheme Description Schema and Language to describe IPMP control information and tool information commonly used for MPEG-21 IPMP system to protect MPEG-21 content;
Creating IPMP scheme descriptor with IPMP information inside based on the said IPMP Scheme Description Schema and Language when a MPEG-21 DID with its referred Resource is created and encoded;
Producing IPMP descriptor, part of the said IPMP scheme descriptor, based on the said IPMP Scheme Description Schema and Language to specify necessary IPMP information like completely described IPMP Tool information and related control message for specific protected Resource;
Incorporating the said IPMP scheme descriptor to the said MPEG-21 DID in a specified place to meet the MPEG-21 IPMP system specifications, to be distributed to Users;
Placing the said IPMP descriptor in nearest Resource Descriptor within the same Component parent element under the said MPEG-21 DID, to be distributed to Users;
Implementing a MPEG-21 terminal with building a IPMP Parser based on the said IPMP Scheme Description Schema and Language to extract the said IPMP scheme descriptor from the said DID and transfer them to MPEG-21 IPMP tool Manager/Message Router;
Building the said terminal with the said Tool Manager/Message Router to interpret the said IPMP information inside the said IPMP scheme descriptor and enforce the protection on the MPEG-21 content in the said terminal.
Receiving the said DID and its referred Resource with the said IPMP information in the said IPMP descriptor in the said terminal;
Extracting the said IPMP descriptor with the said IPMP information from the received DID;
Parsing the said IPMP scheme descriptor by the said IPMP Parser in the said terminal and transferring the said IPMP information to IPMP Tool Manager/Message Router;
Interpreting the said IPMP information by IPMP Tool Manager/Message Router to activate the protection on Resources in the said terminal.
   (7) Methods of IPMP Scheme Description for Digital Item in MPEG-21 Architecture, where Incorporating the Said IPMP Scheme Descriptor to the Said DID, in One of the Above Items (1), (2), (3) (4), (5), and (6), Further Including the Following Steps of:
Encrypting the said whole DID (a DIDL file) using any existing encryption algorithm;
Distributing the said encrypted DID with the inside IPMP information to the said Users.
   (8) Methods of IPMP Scheme Description for Digital Item in MPEG-21 Architecture, where Incorporating the Said IPMP Scheme Descriptor to the Said DID, in One of the Above Items (1), (2), (3) (4), (5), and (6) Further Including the Following Steps of:
Digital signing the said whole DID (a DIDL file) using any digital signature algorithm;
Distributing the said signed DID with the inside IPMP information to the said Users.
   (9) Methods of IPMP Scheme Description for Digital Item in MPEG-21 Architecture, where Incorporating the Said IPMP Scheme Descriptor to the Said DID, in One of the Above Items (1), (2), (3) (4), (5), and (6) Further Including the Following Steps of:
Encrypting just the said IPMP scheme descriptor using any existing encryption algorithm;
Incorporating the said encrypted IPMP scheme descriptor with the said IPMP information to the said DID.
   (10) Methods of IPMP Scheme Description for Digital Item in MPEG-21 Architecture, where Incorporating the Said IPMP Scheme Descriptor to the Said DID, in One of the Above Items (1), (2), (3) (4), (5), and (6) Further Including the Following Steps of:
Digital signing just the said IPMP scheme descriptor using any digital signature algorithm;
Incorporating the said signed IPMP scheme descriptor with the said IPMP information to the said DID.
   (11) Methods of IPMP Scheme Description for Digital Item in MPEG-21 Architecture, where Extracting the Said IPMP Descriptor with the Said IPMP Information from the Received DID, in One of the Above Items (2), (3) (4), (5), and (6) Further Including the Following Steps of:
Parsing the said DID by the DID Parser in the said terminal;
Detecting the said IPMP scheme descriptor inside the said DID when the said DID parser meeting the IPMP_Scheme tags of the said IPMP scheme descriptor;
Extracting the said IPMP descriptor with the said IPMP information from the received DID by the said IPMP_Scheme tags and parsing the said IPMP scheme descriptor by the said IPMP Parser.
   (12) Methods of IPMP Scheme Description for Digital Item in MPEG-21 Architecture, where Parsing the Said IPMP Scheme Descriptor by the Said IPMP Parser in the Said Terminal, in One of the Above Items (2), (3) (4), (5), and (6) Further Including the Following Steps of:
Parsing the said IPMP scheme descriptor by the said IPMP Parser in the said terminal;
Detecting the REL information inside the said IPMP scheme descriptor when the said IPMP parser meeting the REL tags of the said IPMP scheme descriptor;
Extracting the said REL information from the said IPMP scheme descriptor by the said REL tags and parsing the said REL information by the REL Parser;
Transferring the behaviour information of the said rights information to each component in the said terminal, to activate the said rights and usage rules described by the said REL information.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A Method of processing IPMP Scheme description for Digital Item in a server, comprising the following steps of:
Based on a flexible IPMP Scheme Description Schema and Language to describe IPMP control information and tool information commonly used for IPMP system to protect content, creating an IPMP scheme descriptor with IPMP information inside based on the IPMP Scheme Description Schema and Language when a Digital Item Declaration (DID) with its referred resource is created and encoded;
Incorporating the IPMP scheme descriptor to the did in a specified place to be distributed to users; and
transferring the did to a terminal,
wherein the terminal includes an IPMP parser which operates based on the IPMP scheme description schema and language to extract the IPMP scheme descriptor from the did, and
wherein the terminal includes one of a Tool Manager and Message Router to interpret the IPMP information inside the IPMP scheme descriptor extracted and transferred by the IPMP parser and enforce protection on the content in the terminal.

2. A Method of processing IPMP Scheme description for Digital Item in the server according to claim 1, further comprising the following step of:
Producing IPMP control information descriptor, as part of the IPMP scheme descriptor, based on the IPMP Scheme Description Schema and Language to specify necessary IPMP information on one of Tool List, IPMP Tool Holder and IPMP Rights Holder.

3. A Method of processing IPMP Scheme description for Digital Item in the server according to claim 2, further comprising the following step of:
Placing the IPMP control information descriptor under the DID at the beginning of Container Descriptor's Statement element, to be distributed to Users;

4. A Method of processing IPMP Scheme description for Digital Item in the server according to claim 1, comprising the following step of:
Producing an IPMP descriptor, as a part of the IPMP scheme descriptor, based on the IPMP Scheme Description Schema and Language to specify necessary IPMP information on one of completely described IPMP Tool information and related control message for specific protected resource.

5. A Method of processing IPMP Scheme description for Digital Item in the server according to claim 4, comprising the following step of:
Placing the IPMP descriptor in the nearest resource Descriptor within the same Component parent element under the DID, to be distributed to Users;

6. A Method of processing IPMP Scheme description for Digital Item in the server according to claim 1, comprising the following steps of:
Encrypting the whole DID (a DIDL file) using any existing encryption algorithm; and
Distributing the encrypted DID with the inside IPMP information to the Users.

7. A Method of processing IPMP Scheme description for Digital Item in the server according to claim 1, comprising the following steps of:
Digitally signing the whole DID (a DIDL file) using any digital signature algorithm; and
Distributing the signed DID with the inside IPMP information to the Users.

8. A Method of processing IPMP Scheme description for Digital Item in the server according to claim 1, comprising the following steps of:
Encrypting just the IPMP scheme descriptor using any existing encryption algorithm; and
Incorporating the encrypted IPMP scheme descriptor with the IPMP information to the DID.

9. A Method of processing IPMP Scheme description for Digital Item in the server according to claim 1, comprising the following steps of:
Digitally signing just the IPMP scheme descriptor using any digital signature algorithm; and
Incorporating the signed IPMP scheme descriptor with the IPMP information to the DID.

10. A Method of processing IPMP Scheme description for Digital Item in the server according to claim 1, wherein:
a DID Parser in the terminal parses the DID;
the DID parser detects the IPMP scheme descriptor inside the DID when the DID parser meets the IPMP_Scheme tags of the IPMP scheme descriptor; and
the IPMP Parser extracts the IPMP descriptor with the IPMP information from the received DID by the IPMP_Scheme tags and parses the IPMP scheme descriptor.

11. A Method of processing IPMP Scheme description for Digital Item in the server according to claim 1, wherein:
the IPMP Parser in the terminal parses the IPMP scheme descriptor;
the IPMP Parser detects REL information inside the IPMP scheme descriptor when the IPMP parser meets a REL tag of the IPMP scheme descriptor;
an REL Parser extracts the REL information from the IPMP scheme descriptor by the REL tag and parses the REL information; and
the REL Parser transfers behaviour information of rights information to each component in the terminal, to activate rights and usage rules described by the REL information.

12. The Method of processing IPMP Scheme description for Digital Item in a terminal,
wherein, based on a flexible IPMP Scheme Description Schema and Language to describe IPMP control information and tool information commonly used for IPMP system to protect content, a server creates an IPMP scheme descriptor with IPMP information inside based on the IPMP Scheme Description Schema and Language when a Digital Item Declaration (DID) with its referred resource is created and encoded;
wherein the server incorporates the IPMP scheme descriptor to the DID in a specified place to be distributed to Users; and
wherein the server transfers the DID to a terminal which is installed with an IPMP Parser based on the IPMP Scheme Description Schema and Language to extract the IPMP scheme descriptor from the DID;
the method comprising steps of:
Receiving the DID and its referred resource with the IPMP information in the IPMP scheme descriptor in the terminal;
Extracting the IPMP scheme descriptor with the IPMP information from the received DID;
Parsing the IPMP scheme descriptor by the IPMP Parser in the terminal;
transferring the IPMP information to one of IPMP Tool Manager and Message Router in the terminal,
Interpreting the IPMP information inside the IPMP scheme descriptor which enforces protection on the content in the terminal, and
Activating the protection on resources in the terminal.

13. A Method of processing IPMP Scheme description for Digital Item in the terminal according to claim 12, wherein the server produces IPMP control information descriptor, as a part of the IPMP scheme descriptor, based on the IPMP Scheme Description Schema and Language to specify necessary IPMP information on one of Tool List, IPMP Tool Holder and IPMP Rights Holder.

14. A Method of processing IPMP Scheme description for Digital Item in the terminal according to claim 12, wherein the server produces an IPMP descriptor, as a part of the IPMP scheme descriptor, based on the IPMP Scheme Description Schema and Language to specify necessary IPMP information on one of completely described IPMP Tool information and related control message for specific protected resource.

15. A Method of processing IPMP Scheme description for Digital Item in the terminal according to claim 14, wherein the server places the IPMP descriptor in the nearest resource Descriptor within the same Component parent element under the DID, to be distributed to Users.

16. A Method of processing IPMP Scheme description for Digital Item in the terminal according to claim 12, comprising the following step of:
Parsing the DID by a DID Parser in the terminal;
Detecting the IPMP scheme descriptor inside the DID when the DID parser meets the IPMP_Scheme tags of the IPMP scheme descriptor;
Extracting the IPMP descriptor with the IPMP information from the received DID by the IPMP_Scheme tags and parsing the IPMP scheme descriptor by the IPMP Parser.

17. A Method of processing IPMP Scheme description for Digital Item in the terminal according to claim 12, comprising the following step of:
Parsing the IPMP scheme descriptor by the IPMP Parser in the terminal;
Detecting REL information inside the IPMP scheme descriptor when the IPMP parser meets an REL tag of the IPMP scheme descriptor;
Extracting the REL information from the IPMP scheme descriptor by the REL tag and parsing the REL information by the REL Parser;
Transferring behaviour information of rights information to each component in the terminal, to activate rights and usage rules described by the REL information.

18. A server which processes IPMP Scheme description for Digital Item, comprising:
an encoder which encodes a content to create a resource;
a processor which creates a Digital Item Declaration (DID) with its referred resource, which creates an IPMP scheme descriptor with IPMP information inside based on a flexible IPMP Scheme Description Schema and Language to describe IPMP control information and tool information commonly used for IPMP system to protect content, and which incorporates the IPMP scheme descriptor to the DID in a specified place to be distributed to Users; and
a transmitter which transmits the DID to a terminal.

19. A terminal which processes IPMP Scheme description for Digital Item, comprising:
a receiver which receives, from a server, a Digital Item Declaration (DID) and its referred resource with IPMP information in an IPMP scheme descriptor based on the IPMP Scheme Description Schema and Language to describe IPMP control information and tool information commonly used for IPMP system to protect content,
an extractor which extracts the IPMP scheme descriptor with the IPMP information from the received DID;
an IPMP parser which parses the IPMP scheme descriptor; and
one of an IPMP Tool Manager and a Message Router which interprets the IPMP information inside the IPMP scheme descriptor transferred from the IPMP parser, and which enforces protection on the content in the terminal by activating the protection on resources.
